(19) United States
(12) Patent Application Publication
(10) Pub. No.: US 2005/0077719 A1
(43) Pub. Date: Apr. 14, 2005

(54) Sleeve for a score-card

(76) Inventor: Thomas Wenger, Ottobeuren (DE)

Correspondence Address: JORDAN AND HAMBURG LLP, 122 EAST 42ND STREET, SUITE 4000, NEW YORK, NY, 10168, US

(21) Appl. No.: 10/500,995

(22) PCT Filed: Jan. 21, 2003
(86) PCT No.: PCT/DE03/00165

(30) Foreign Application Priority Data
Jan. 21, 2002 (DE) 102 02 079.5

(51) Int. Cl. B42D 3/00

(52) U.S. Cl. 281/29

(57) ABSTRACT

A sleeve is provided for accommodating a scorecard which can be inserted between an outer wall and an inner wall, which forms only an edge strip, so that it is possible to write on the scorecard through a recess in the inner wall.

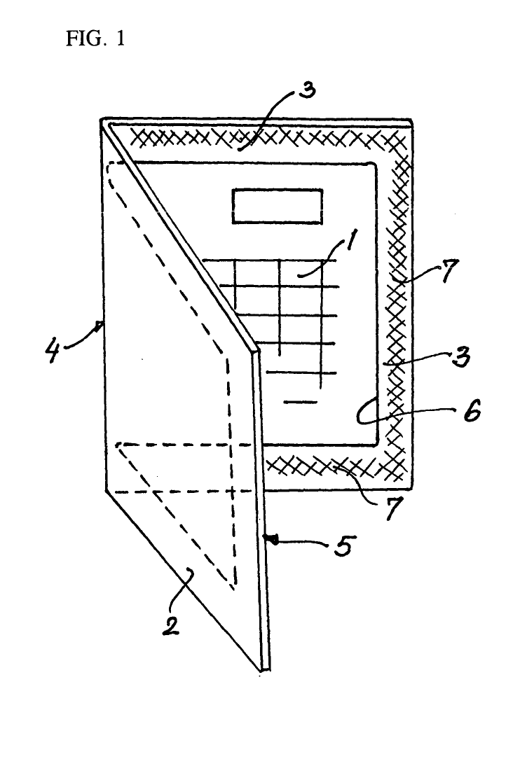

The invention starts out from a sleeve for accommodating a scorecard, the scorecard being disposed between a closed outer wall and an inner wall so that the scorecard can be inspected from the outside, according to the class of the main claim.

It is a known problem of such scorecards that leisure sports, such as golf, are not infrequently played in moist or even rainy weather and an unprotected scorecard, on which the results of the player are entered, is crumpled or softened by the moisture. As a result, it is appreciably more difficult to enter data and it may also happen that the data, already entered, is lost. Another result may be that appreciable fees, for the calculation of which this data is required, are lost,.

For a known sleeve of the type of this class (German utility patent 20012340), the sleeve consists of a watertight, welded sheet, on the inner side of which sleeve, opposite to the printed scorecard form, there is a coating, which consists of a two-component, micro-encapsulated, automatically copying system.

By pressing a pencil from the outside onto the sheet, the microcapsules are destroyed and transfer the number or letter written in high contrast onto the scorecard. Aside from the fact that a new sleeve would have to be used for each round of golf, since a portion of these microcapsules has already been destroyed through use, such a device is very expensive. Moreover, in some cases, corrections have to be made on the scorecard by erasing or correcting previous entries. This is hardly possible with such a sheet pocket sleeve.

In comparison, the inventive sleeve with the characterizing distinguishing features of the main claim has the advantage that, on one side, it is protected towards the outside against moisture, offers direct access to the scorecard simply after being flipped open and last, but not least, can be slipped conveniently into a pocket in the trousers or jacket. The size of such a scorecard advantageously is of the order of DINA6, that is, approximately twice the size of a somewhat larger wallet.

According to an advantageous development of the invention, means are present for holding the sleeve in the folded state, these means, pursuant to the invention, consisting of an at least partially peripheral Velcro seal or of a connecting tab, which adheres, for example, by a Velcro seal. According to an additional, advantageous development of the invention, there is printing for informational purposes, especially for advertising purposes on the outer wall. The printing may, for example, be a numbering system, a name or any other advertising information.

According to an additional, advantageous development of the invention, leather or a leather-like material, which is moisture-impregnated or not hygroscopic, is used as sleeve material. Moreover, such a sleeve can be connected with a writing implement, such as a pencil, by means of an appropriate sleeve or the like, in order to have such an implement at hand immediately after a handicap or other result is determined.

Further advantages and advantageous developments of the invention can be inferred from the following description, the drawing and the claims.

An example of the object of the invention is shown in a simplified fashion in the drawing and described in greater detail in the following.

The sleeve for a scorecard 1, shown in the drawing, has an outer wall 2 and an inner wall 3 and can be folded about an edge 4.

In the flipped-open state, the scorecard can be inserted between the two walls 2 and 3 in the sleeve through a lateral gap 4, the printed region of the scorecard being directly accessible over a recess 6 in the inner wall 3, so that it can be written upon. When folded together completely, in which case the two halves of the inner wall 3, formed by the fold, lie on top of one another, the scorecard 1 is protected against external influences, especially against moisture.

A Velcro seal is provided on the edge strip, which remains as inner wall 3 in order to ensure by these means that, on the one hand, there is a type of seal towards the outside and, on the other, that the given fold is retained. For writing on the scorecard 1, the Velcro seal is unlatched.

All the distinguishing features may be essential to the invention individually as well as in any combination with one another.

1. A sleeve for accommodating a scorecard comprising a closed outer wall and an inner wall between which the scorecard is disposed wherein the scorecard can be inspected from the outside and can be folded easily, by means of which, after the folding, the thereby divided inner wall halves lie on top of one another and whereby, after the folding, a printed field of the scorecard is visible once again, wherein the inner wall has a recess exposing the printed part of the scorecard and that, opposite the inside of the outer wall at least an edge of the recess remains for holding the scorecard.

2. The sleeve of claim 1, wherein a construction is provided for holding together the parts folded on top of one another.

3. The sleeve of claim 2, wherein a Velcro seal, disposed in the edge region, forms said construction.

4. The sleeve of claim 2, wherein a connecting tab is used as said construction.

5. The sleeve of claim 1, wherein for informational purposes, there is printing on the outer wall.

6. The sleeve of claim 1, wherein leather is used as a sleeve material.

7. The sleeve of claim 1, wherein at a front face, between the outer wall and the inner wall, a slot is provided for inserting the scorecard between the walls.
